(19) United States
(12) Patent Application Publication
(10) Pub. No.: US 2026/0148724 A1
(43) Pub. Date: May 28, 2026

(54) ACOUSTIC STRUCTURES

(71) Applicant: ARMSTRONG WORLD INDUSTRIES, INC., Lancaster, PA (US)

(72) Inventors: Christopher D. Gaydos, Lancaster, PA (US); Ming Chen, East Petersburg, PA (US)

(73) Assignee: ARMSTRONG WORLD INDUSTRIES, INC., Lancaster, PA (US)

(21) Appl. No.: 19/290,421

(22) Filed: Aug. 5, 2025

Related U.S. Application Data
(60) Provisional application No. 63/679,238, filed on Aug. 5, 2024.

(51) Int. Cl. G10K 11/168; B32B 3/12; B32B 7/12; B32B 17/02; B32B 23/08; B32B 29/00; E04B 1/99

(52) U.S. Cl. CPC G10K 11/168; B32B 3/12; B32B 7/12; B32B 17/02; B32B 23/08; B32B 29/002; E04B 1/99; B32B 2250/05; B32B 2307/102; B32B 2307/72; B32B 2307/7376

(57) ABSTRACT

An acoustic structure includes a first core layer having a lattice structure between a first major surface and a second major surface, a first scrim coupled to the first major surface, a second scrim coupled to the second major surface, a second core layer having a lattice structure between a first major surface opposite a second major surface coupled to the second scrim, and a third scrim coupled to the second major surface of the second core layer. The acoustic structure has a bulk density of less than about 12 pounds per cubic foot.

### CROSS-REFERENCE TO RELATED APPLICATION

This application claims priority to U.S. patent application Ser. No. 63/679,238 filed on Aug. 5, 2024, the disclosures of which are incorporated herein by reference in their entirety.

### FIELD OF DISCLOSURE

The present disclosure relates to lightweight acoustic structures and methods for making the same.

### BACKGROUND

Building materials, such as blades, planks, and panels for ceiling and wall systems, may be designed balance interests with respect to aesthetics, material cost, structural integrity, weight, acoustics, and environmental impact.

Accordingly, those skilled in the art continue research and development in the field of lightweight acoustic structures.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The present disclosure is directed to lightweight acoustic structures, such as blades.

In one example, the acoustic structure includes a first core layer having a lattice structure between a first major surface opposing a second major surface and a side surface, first scrim coupled to the first major surface, a second scrim coupled to the second major surface, a first veneer layer over the first scrim, second veneer layer over the second scrim, and a third veneer layer over a side surface of a stacked structure defined by the first core layer, second core layer, first scrim, and second scrim. The acoustic structure 100 has a bulk density of less than 12 pounds per cubic foot, less than about 11 pounds per cubic foot, less than about 10 pounds per cubic foot, less than about 9 pounds per cubic foot, less than about 8 pounds per cubic foot, less than about 7 pounds per cubic foot, or less than about 6 pounds per cubic foot. In another example, the acoustic structure 100 has a bulk density ranging from about 6 pounds per cubic foot to about 10 pounds per cubic foot.

In one example, the first core layer includes a cellulosic material. In one example, the first core layer includes kraft paper. In one example, the first core layer includes a honeycomb structure. In one example, the core layer includes a tri-lattice structure. In one example, the first core layer is impregnated with a resin. In one example, the first core layer includes a density of less than about 5 pounds per cubic foot. In one example, the first core layer includes a thickness ranging from about 0.5″ to about 23″.

In one example, the first scrim includes fiberglass. In one example, the first scrim and the second scrim comprise fiberglass. In one example, the first scrim and the second scrim each have an air flow resistance ranging from about 80 Rayls to about 400 Rayls.

In one example, the acoustic structure further includes a coating over the first veneer layer, the second veneer layer, and the third veneer layer. In one example, the first veneer layer, the second veneer layer, and the third veneer layer are microperforated with a plurality of microperforations. In one example, each perforation of the plurality of microperforations has a diameter ranging from about 0.3 mm to about 1 mm. In one example, the plurality of microperforations are present in an amount ranging from about 50,000 microperforations/m² to about 200,000 microperforations/m². In one example, the first veneer layer, the second veneer layer, and the third veneer layer comprise a cellulosic material. In one example, the first veneer layer is laminated to the first scrim with an adhesive. In one example, the first veneer layer is screen printed onto the first scrim. In one example, the acoustic structure further includes a coating over the first veneer layer, the second veneer layer, and the third veneer layer.

In another example, the acoustic structure includes a first core layer having a lattice structure between a first major surface and a second major surface, a first scrim coupled to the first major surface, a second scrim coupled to the second major surface, a second core layer having a lattice structure between a first major surface opposite a second major surface coupled to the second scrim, and a third scrim coupled to the second major surface of the second core layer.

In one example, at least one of the first core layer and the second core layer includes a cellulosic material. In one example, at least one of the first core layer and the second core layer includes kraft paper. In one example, at least one of the first core layer and the second core layer includes a honeycomb structure. In one example, at least one of the first core layer and the second core layer includes a tri-lattice structure. In one example, the first core layer includes a honeycomb structure and the second core layer includes a tri-lattice structure. In one example, at least one of the first core layer and the second core layer is impregnated with a resin. In one example, at least one of the first core layer and the second core layer is chemically treated with one or more of ammonium sulphate, ammonium phosphate, and borax for fire-resistance. In one example, at least one of the first core layer and the second core layer includes a density of less than about 5 pounds per cubic foot. In one example, at least one of the first core layer and the second core layer includes a thickness ranging from about 0.5′ to about 2′. In one example, the first core layer and the second core layer have substantially the same thickness. In one example, the first core layer and the second core layer are positioned such that the lattice structure of the first core layer is offset from the lattice structure of the second core layer.

In one example, the first scrim includes fiberglass. In one example, the first scrim, the second scrim, and the third scrim comprise fiberglass. In one example, the first scrim, the second scrim, and the third scrim each have an air flow resistance ranging from about 80 Rayls to about 400 Rayls.

In one example, the acoustic structure further includes a first veneer layer over the first scrim, a second veneer layer over the third scrim, and a third veneer layer over a side surface of a stacked structure defined by the first core layer, second core layer, first scrim, second scrim, and third scrim. In one example, the first veneer layer, the second veneer layer, and the third veneer layer are microperforated with a plurality of microperforations. In one example, each perforation of the plurality of microperforations has a diameter ranging from about 0.3 mm to about 1 mm. In one example, the plurality of microperforations are present in an amount ranging from about 50,000 microperforations/m² to about 200,000 microperforations/m². In one example, the first veneer layer, the second veneer layer, and the third veneer layer comprise a cellulosic material. In one example, the first veneer layer is laminated to the first scrim with an adhesive. In one example, the first veneer layer is screen printed onto the first scrim. In one example, the acoustic structure further includes a coating over the first veneer layer, the second veneer layer, and the third veneer layer.

Also disclosed is an acoustic system.

In one example, the acoustic system includes a support structure, a first acoustic structure coupled to the support structure, and a second acoustic structure horizontally offset by a lateral offset distance from the first acoustic structure along the support structure. Each of the first acoustic structure and the second acoustic structure includes a core layer having a lattice structure between a first major surface opposing a second major surface and a side surface, a first scrim coupled to the first major surface, a second scrim coupled to the second major surface, first veneer layer over the first scrim, a second veneer layer over the second scrim and a third veneer layer over the side surface. The acoustic structure has a bulk density ranging from about 7.96 pounds per cubic foot to about 9.68 pounds per cubic foot.

In one example, the core layer includes a cellulosic material. In one example, the core layer includes kraft paper. In one example, the core layer includes a honeycomb structure. In one example, the core layer includes a tri-lattice structure. In one example, the core layer is impregnated with a resin. In one example, the core layer includes a density of less than about 5 pounds per cubic foot. In one example, the core layer includes a thickness ranging from about 0.5″ to about 2″.

In one example, the first scrim and the second scrim comprise fiberglass. In one example, the first scrim and the second scrim each have an air flow resistance ranging from about 80 Rayls to about 400 Rayls. In one example, each acoustic structure includes a coating over the first veneer layer, the second veneer layer, and the third veneer layer.

In one example, the first veneer layer, the second veneer layer, and the third veneer layer are microperforated with a plurality of microperforations. In one example, each perforation of the plurality of microperforations has a diameter ranging from about 0.3 mm to about 1 mm. In one example, the plurality of microperforations are present in an amount ranging from about 50,000 microperforations/m² to about 200,000 microperforations/m². In one example, the first veneer layer, the second veneer layer, and the third veneer layer comprise a cellulosic material. In one example, the first veneer layer is laminated to the first scrim with an adhesive. In one example, the first veneer layer is screen printed onto the first scrim.

Also disclosed is a method for manufacturing an acoustic structure.

In one example, the method includes cutting a substrate having a first major surface opposing a second major surface and a lattice structure extending between the first major surface and second major surface to yield a first core layer having a first major surface opposing a second major surface, cutting the substrate to yield a second core layer having a first major surface opposing a second major surface, coupling a first scrim to the first major surface of the first core layer and a second scrim to the second major surface of the first core layer, coupling the first major surface of the second core layer to the second major surface of the first core layer, coupling a third scrim to the second major surface of the second core layer, coupling a first veneer layer to the first major surface of the first core layer, coupling a second veneer layer to the second major surface of the second core layer to yield a stacked structure, and coupling a third veneer layer to a side surface of the stacked structure to yield the acoustic structure.

In one example, at least one of the first core layer and the second core layer includes a cellulosic material. In one example, at least one of the first core layer and the second core layer includes kraft paper. In one example, at least one of the first core layer and the second core layer includes a honeycomb structure. In one example, at least one of the first core layer and the second core layer includes tri-lattice structure. In one example, at least one of the first core layer and the second core layer includes is impregnated with a resin. In one example, at least one of the first core layer and the second core layer includes a density of less than about 5 pounds per cubic foot, less than about 4 pounds per cubic foot, or less than about 3 pounds per cubic foot. In one example, at least one of the first core layer and the second core layer includes a thickness ranging from about 0.5″ to about 2″.

In one example, the first scrim includes fiberglass. In one example, the first scrim, the second scrim, and the third scrim comprise fiberglass. In one example, the first scrim and the second scrim each have an air flow resistance ranging from about 80 Rayls to about 400 Rayls.

In one example, the acoustic structure includes a coating over the first veneer layer, the second veneer layer, and the third veneer layer. In one example, the first veneer layer, the second veneer layer, and the third veneer layer are microperforated with a plurality of microperforations. In one example, each perforation of the plurality of microperforations has a diameter ranging from about 0.3 mm to about 1 mm. In one example, the plurality of microperforations are present in an amount ranging from about 50,000 microperforations/m² to about 200,000 microperforations/m². In one example, the first veneer layer, the second veneer layer, and the third veneer layer comprise a cellulosic material. In one example, the first veneer layer is laminated to the first scrim with an adhesive. In one example, the first veneer layer is screen printed onto the first scrim.

In one example, the cutting yields a first core layer having a side surface defined by frayed edges of the lattice structure. In one example, the method includes a coating over the first veneer layer, the second veneer layer, and the third veneer layer. In one example, the method includes applying an adhesive to the first major surface of the first core layer and the second major surface of the first core layer prior to applying the first scrim and the second scrim. In one example, the method further includes pressing the first scrim against the first major surface and pressing the second scrim against the second major surface of the first core layer.

### BRIEF DESCRIPTION OF THE DRAWINGS

FIG. 1 is a perspective view of an acoustic structure;

FIG. 2 is a front view of the acoustic structure of FIG. 1;

Fig, 3 is a side view of the acoustic structure of FIG. 1;

FIG. 4 is a perspective view of an acoustic system;

FIG. 5 is a side view of the acoustic system of FIG. 4;

FIG. 6 is a cross-sectional view of a portion of the acoustic structure of FIG. 1;

FIG. 7 is a cross-sectional view of a portion of an acoustic structure;

FIG. 8A is a perspective view of a portion of an acoustic structure; and

FIG. 8B is an exploded view of the acoustic structure of FIG. 8A.

The detailed description of the disclosure will be better understood when read in conjunction with the appended drawings. It should be understood, however, that the disclosure is not limited to the precise arrangements and instrumentalities of the examples shown in the drawings.

### DETAILED DESCRIPTION

For illustrative purposes, the principles of the present disclosure are described by referencing various examples thereof. Although certain examples of the disclosure are specifically described herein, one of ordinary skill in the art will readily recognize that the same principles are equally applicable to, and can be employed in other applications and methods. It is to be understood that the disclosure is not limited in its application to the details of any particular example shown. The terminology used herein is for the purpose of description and not to limit the disclosure, its application, or uses.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, “containing”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range. Thus, any range of values disclosed herein is merely exemplary and includes all values and sub-ranges there-between

Unless otherwise specified, all percentages and amounts expressed herein and elsewhere in the specification should be understood to refer to percentages by weight of the total composition. Unless otherwise specified, reference to a molecule, or to molecules, being present at a “wt. %” refers to the amount of that molecule, or molecules, present in the composition based on the total dry-weight of the composition. Unless otherwise specified, reference to a molecule, or to molecules, being present “based on the dry weight of the composition” refers to that molecule, or molecules, being present in the composition based on the total dry-weight of the composition in a dry state. The “dry state” refers to solvent being present in the composition at an amount less than 5.0 wt. %, less than about 3.0 wt. %, less than about 1.0 wt. %; preferably less than about 0.5 wt. %, and more preferably less than about 0.25 wt. % of the composition. For example, a composition in the dry state may refer to a composition having about 95% solids, about 98% solids, preferably about 99% solids, or more preferably about 100% solids. By contrast, unless otherwise specified, reference to a molecule, or to molecules, being present “based on the wet weight of the composition” refers to that molecule, or molecules, being present in the composition based on the total dry-weight of the composition which includes at least 5 wt. % of solvent.

According to the present application, use of the term “about” in conjunction with a numeral value refers to a value that may be +/−5% of that numeral. As used herein, the term “substantially free” is intended to mean an amount less than about 5.0 wt. %, less than 3.0 wt. %, less than 1.0 wt. %; preferably less than about 0.5 wt. %, and more preferably less than about 0.25 wt. % of the composition.

Unless defined otherwise, all technical and scientific terms used herein have the same meanings as commonly understood by one of ordinary skill in the art to which this disclosure belongs. All patents, patent applications, publications, and other references cited or referred to herein are incorporated by reference in their entireties for all purposes. In the event of a conflict in a definition in the present disclosure and that of a cited reference, the present disclosure Comparatives.

In the description of examples disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing (if applicable) under discussion. These relative terms are for convenience of description only and, unless specified otherwise, do not require that the apparatus be constructed or operated in a particular orientation.

As used herein, terms such as “attached,” “affixed,” “connected,” “coupled,” “interconnected,” and the like refer to a relationship wherein structures are secured or attached to one another either directly or indirectly through intervening structures, as well as both movable or rigid attachments or relationships, unless expressly described otherwise. Accordingly, the disclosure is not limited to such examples illustrating certain combinations of features that may exist alone or in combination with other features.

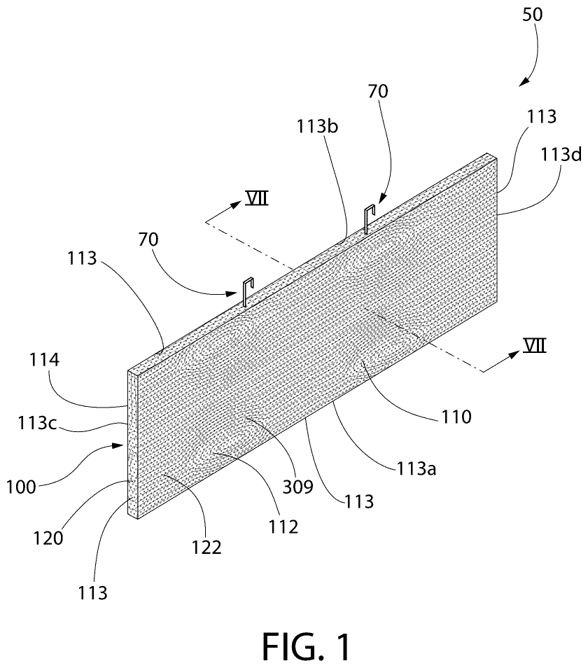

The present disclosure relates to lightweight acoustic structures. Referring to FIG. 1, disclosed is an acoustic structure 100 and building structure assembly 50. The acoustic structure 100 may be suitable as a ceiling structure or a wall structure, such as a panel, blade, lattice, or other aesthetic design, designed to provide acoustic properties as described herein while offering desired aesthetics and being lightweight. The acoustic structure 100 may be part of a building structure assembly 50 such that it is coupled with building attachment hardware 70 configured to removably couple the acoustic structure 100 to a building structure. In one example, the building attachment hardware 70 is integrally formed with the acoustic structure 100. In another example, the building attachment hardware 70 is removably attachable to the acoustic structure 100.

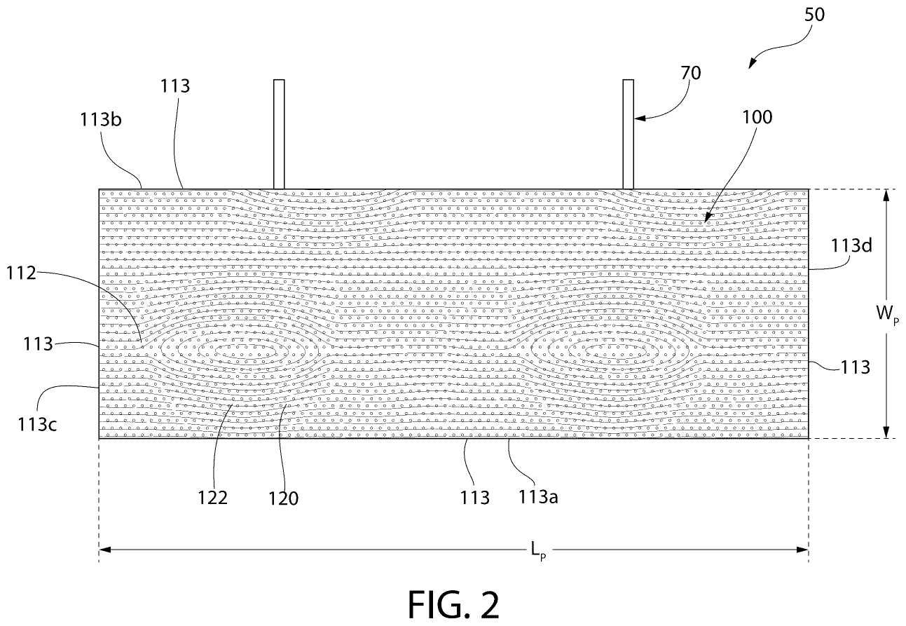

Referring to FIG. 2, the acoustic structure 100 is characterized by a width W_{P} ranging from about 4″ to 32″. The acoustic structure 100 is further characterized by a length L_{P} ranging from about 12″ to about 144″. Referring to FIG. 3, the acoustic structure 100 is further characterized by its thickness t_{P} ranging from about ¾″ to about 2″. The acoustic structure 100 has a bulk density of less than 12 pounds per cubic foot, less than about 11 pounds per cubic foot, less than about 10 pounds per cubic foot, less than about 9 pounds per cubic foot, less than about 8 pounds per cubic foot, less than about 7 pounds per cubic foot, or less than about 6 pounds per cubic foot. In another example, the acoustic structure 100 has a bulk density ranging from about 6 pounds per cubic foot to about 10 pounds per cubic foot.

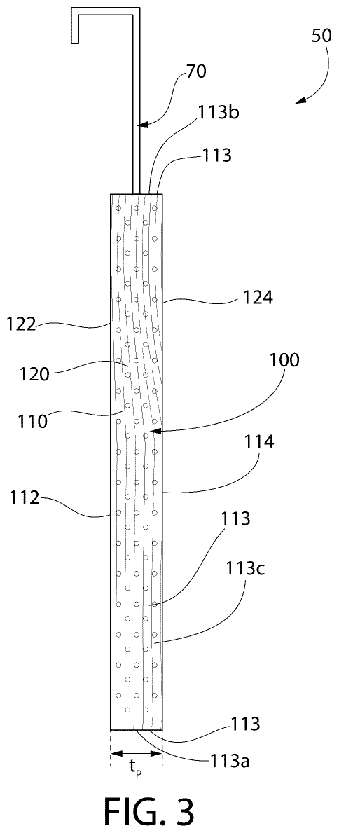

Referring to FIG. 4, the acoustic structure 100 includes a first major exposed surface 112 opposite a second major exposed surface 114 and a side exposed surface 113 extending therebetween. The side exposed surface includes a first exposed side 113a, a second exposed side 113b, a third exposed side 113c, and a fourth exposed side 113d. Ihe building attachment hardware 70 may be coupled to the second exposed side surface 113b of acoustic structure 100. In another example, the building attachment hardware 70 may be coupled to either the first and/or second major exposed surfaces 112, 114 of the acoustic structure 100 at a location immediately adjacent to the second side exposed surface 113b of the acoustic structure 100.

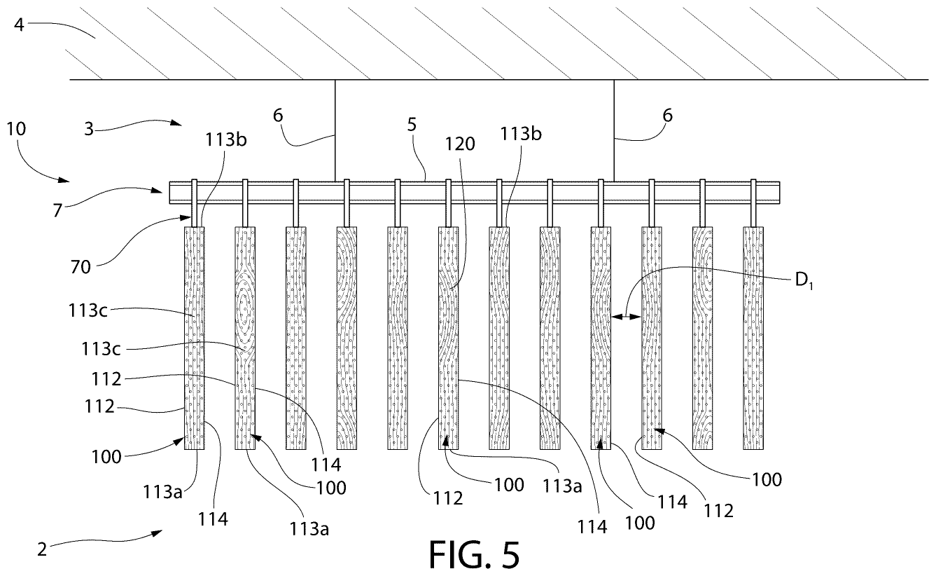

Referring to FIG. 6, the acoustic structure 100 includes a first core layer 110 having a first major surface 116 opposite a second major surface 118 and a side surface 115 extending therebetween. The side surface includes a first side 115a, a second side 115b, a third side 115c, and a fourth side 115d.

In one or more examples, the first core layer 110 includes a lattice structure 117. The lattice structure 117 defines the area between and within the first major surface 116, second major surface 118, and side surface 115. The side surface 115 may be discontinuous such that it is defined by the pattern of the lattice structure 117. In one example, the lattice structure 117 is a honeycomb structure. In another example, the lattice structure 117 is a tri-lattice structure.

In one or more examples, the first core layer 110 includes a cellulosic material. In another example, the first core layer 110 includes a recycled material, such as recycled PET. In one example, the first core layer 110 includes kraft paper. The first core layer 110 may be impregnated with a resin material such phenolic resin, vinyl ester, and acrylic with ATH. The first core layer 110 may be chemically treated with one or more of a phosphate or sulfate, such as borax, ammonium phosphate, and ammonium sulfate, for making the material fire resistant, moisture resistant, and mold resistant.

The first core layer 110 may be further defined by its material properties, specifically its lightweight materials. In one example, the first core layer 110 has a thickness of 1″ and an areal density of less than about 0.25 lb per square foot. In another example, the first core layer 110 an areal density of less than about 1.5 lb per board foot. In another example, the first core layer 110 has an areal density of less than about 0.75 lb per board foot. In another example, the first core layer 110 includes a thickness ranging from about 0.5″ to about 2″.

In one or more examples, the acoustic structure 100 further includes first scrim 130 coupled to the first major surface 116. The first scrim 130 may be comprised of a non-flammable material, such as fiberglass. In one example, the first scrim 130 has an air flow resistance ranging from about 80 Rayls to about 400 Rayls. The first scrim 130 may further include a printed aesthetic layer, such as a woodgrain pattern, for aesthetic preference.

In one or more examples, the acoustic structure 100 further includes a second scrim 132 coupled to the second major surface 118. The second scrim 132 may be comprised of fiberglass. In one example, the second scrim 132 has an air flow resistance ranging from about 80 Rayls to about 400 Rayls. The second scrim 132 may further include a printed aesthetic layer, such as a woodgrain pattern, for aesthetic preference. In a further example, the second scrim 132 may be different than the first scrim 130.

In one or more examples, the acoustic structure 100 further includes a first veneer layer 140 over the first scrim 130. In one example, the first veneer layer 140 is laminated to the first scrim 130 with an adhesive. In another example, the first veneer layer 140 is screen printed onto the first scrim 130.

The first veneer layer 140 may be comprised of cellulosic materials, such as wood. The first veneer layer 140 may be microperforated with a plurality of microperforations 160. In one example, each perforation 162 of the plurality of microperforations 160 has a diameter ranging from about 0.3 mm to about 1 mm. In one example, the plurality of microperforations 160 is present in an amount ranging from about 50,000 microperforations/m² to about 200,000 microperforations/m².

In one or more examples, the acoustic structure 100 further includes a second veneer layer 142 over the second scrim 132. In one example, the second veneer layer 142 is laminated to the second scrim 132 with an adhesive. In another example, the second veneer layer 142 is screen printed onto the second scrim 132.

The second veneer layer 142 may be comprised of cellulosic materials, such as wood. The second veneer layer 142 may be microperforated with a plurality of microperforations 160. In one example, each perforation 162 of the plurality of microperforations 160 has a diameter ranging from about 0.3 mm to about 1 mm. In one example, the plurality of microperforations 160 is present in an amount ranging from about 50,000 microperforations/m² to about 200,000 microperforations/m².

In one or more examples, the acoustic structure 100 further includes a third veneer layer 144 over a side surface 119 defined by a stacked structure including the first core layer 110, the first scrim 130, and the second scrim 132. In one example, the third veneer layer 144 is laminated to the side surface 119 with an adhesive. In another example, the third veneer layer 143 is screen printed onto the side surface 119.

The third veneer layer 144 may be comprised of cellulosic materials, such as wood. The third veneer layer 144 may be a single band wrapping around the side surface 113 or may be comprised of four pieces defining the third veneer layer 144, the four pieces being 144a, 144b, 144c, and 144d. The third veneer layer 144 may be microperforated with a plurality of microperforations 160. In one example, each perforation 162 of the plurality of microperforations 160 has a diameter ranging from about 0.3 mm to about 1 mm. In one example, the plurality of microperforations 160 is present in an amount ranging from about 50,000 microperforations/m² to about 200,000 microperforations/m².

In one example, the acoustic structure 100 further includes a coating 170 over the first veneer layer 140, the second veneer layer 142, and the third veneer layer 144. The coating 170 may be a flame-retardant coating as disclosed in United States Patent Application Publication No. 20220154454, which is incorporated by reference.

The disclosed acoustic structure 100 may be further characterized by its acoustic properties. NRC is a measure of sound energy absorption of a material. An NRC rating of 0 is a perfect sound reflection material. An NRC rating of 1 is a perfect sound absorption material. In one example, the acoustic structure 100 exhibits an NRC value greater than 0.7. In another example, the acoustic structure 100 exhibits an NRC value greater than 0.75

The disclosed acoustic structure 100 may be further characterized by its Fire Rating. In one example, the acoustic structure 100 is fire resistant such that it has a FSR rating of ASTM E84 Class B or Class A (FSI less than 25, SDI less than 450).

The disclosed acoustic structure 100 may be further characterized by its dimensional stability. For example, the disclosed acoustic structure 100 may be structurally sound such that over an 8′ span, when subjected to temperature and humidity changes, the acoustic structure 100 exhibits bowing is less than ¼″, twist of less than or equal to 1/16″, and side bend of less than 1/16″. The acoustic structure 100 has a bulk density of less than 12 pounds per cubic foot, less than about 11 pounds per cubic foot, less than about 10 pounds per cubic foot, less than about 9 pounds per cubic foot, less than about 8 pounds per cubic foot, less than about 7 pounds per cubic foot, or less than about 6 pounds per cubic foot. In another example, the acoustic structure 100 has a bulk density ranging from about 6 pounds per cubic foot to about 10 pounds per cubic foot.

The disclosed acoustic structure 100 is further characterized by its environmental impact and sustainability. For example, the disclosed acoustic structure 100 is comprised of recyclable materials, mostly cellulosic materials, to meet sustainability standards.

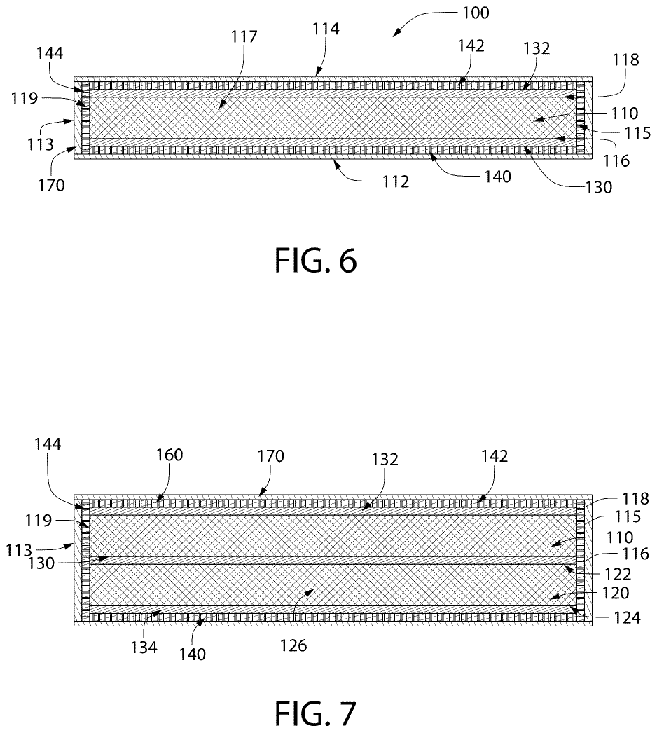

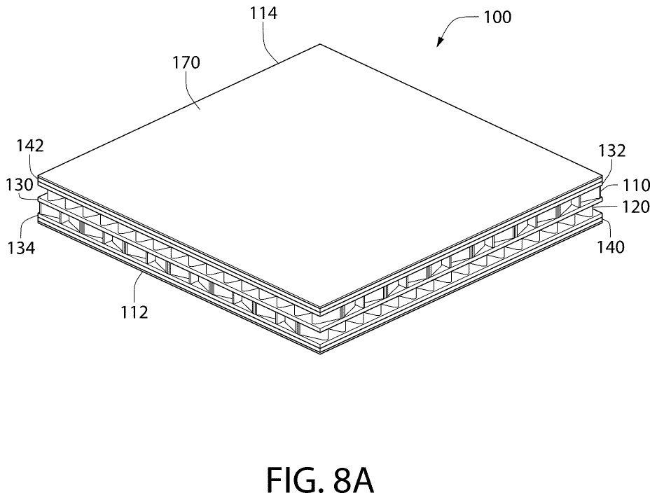

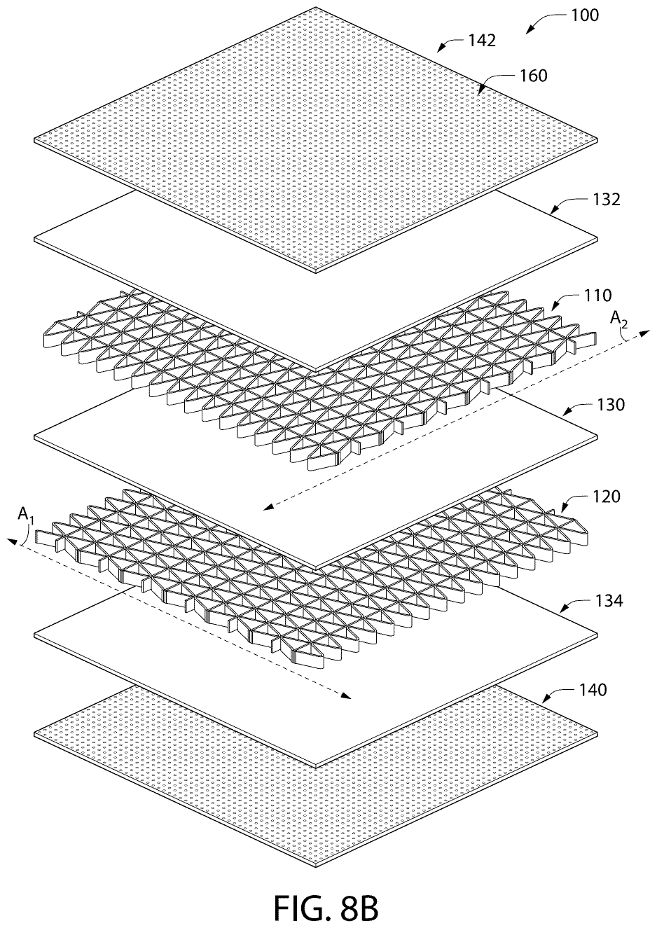

Referring to FIG. 7, FIG. 8A, and FIG. 8B, the acoustic structure 100 may include two core layers 110, 120 as described below. In one example, the acoustic structure 100 includes a first core layer 110 having a lattice structure 116 between a first major surface 112 and a second major surface 114.

In one or more examples, the acoustic structure 100 includes a first scrim 130 coupled to the first major surface 112. The first scrim 130 may be comprised of fiberglass. In one example, the first scrim 130 has an air flow resistance ranging from about 80 Rayls to about 400 Rayls. The first scrim 130 may further include a printed aesthetic layer, such as a woodgrain pattern, for aesthetic preference.

In one or more examples, the acoustic structure 100 includes a second scrim 132 coupled to the second major surface 114. The second scrim 132 may be comprised of fiberglass. In one example, the second scrim 132 has an air flow resistance ranging from about 80 Rayls to about 400 Rayls. The second scrim 132 may further include a printed aesthetic layer, such as a woodgrain pattern, for aesthetic preference. In a further example, the second scrim 132 may be different than the first scrim 130. For instance, the first scrim 130 may have a different airflow resistance than the second scrim 132.

In one or more examples, the acoustic structure 100 further includes a second core layer 120 having a lattice 126 structure between a first major surface 122 opposite a second major surface 124, the first major surface 122 being coupled to the first scrim 130.

In one or more examples, the acoustic structure 100 further includes a third scrim 134 coupled to the second major surface 124 of the second core layer 120. The third scrim 134 may be comprised of fiberglass. In one example, the third scrim 134 has an air flow resistance ranging from about 80 Rayls to about 400 Rayls. The third scrim 134 may further include a printed aesthetic layer, such as a woodgrain pattern, for aesthetic preference. In a further example, the third scrim 134 may be different than the first scrim 130 or the second scrim 132. For instance, the third scrim 134 and the second scrim 132 may have a first airflow resistance and the first scrim 130 may have a second airflow resistance that is different from the first airflow resistance.

In one example, at least one of the first core layer 110 and the second core layer 120 includes a cellulosic material. In another example, at least one of the first core layer 110 and the second core layer 120 includes a recycled material, such as recycled PET. At least one of the first core layer 110 and the second core layer 120 includes kraft paper. In another example, both the first core layer 110 and the second core layer 120 include kraft paper. In yet another example, the first core layer 110 and the second core layer 120 has a density of less than about 5 pounds per cubic foot, less than about 4 pounds per cubic foot, or less than about 3 pounds per cubic foot

In one example, at least one of the first core layer 110 and the second core layer 120 includes a honeycomb structure. In another example, at least one of the first core layer 110 and the second core layer 120 includes a tri-lattice structure. In a further example, the first core layer 110 includes a honeycomb structure and the second core layer 120 includes a tri-lattice structure. In yet a further example, the first core layer 110 and the second core layer 120 are positioned such that the lattice structure 117 of the first core layer 110 is oriented offset from the lattice structure 126 of the second core layer 120. Offsetting the lattice structures of the first core layer 110 and the second core layer 120 may advantageously improve stability and rigidity of the acoustic structure 100.

For example, FIGS. 8A and 8B illustrate the first core layer 110 oriented offset by 90° from the second core layer 120. As shown, the tri-lattice structure of the first core layer 110 is oriented such that the triangles of the structure are oriented in rows extending along a first axis A1, and the tri-lattice structure of the second core layer 120 is oriented such that the triangles of the structure are oriented in rows extending along a second axis A2. The first axis A1 is perpendicular to the second axis A2. Therefore, in one example, the first core layer 110 and the second core layer 120 are oriented in an offset orientations relative to the axes A1 and A2 at approximately 90°. This offset orientation increases mechanical strength of the acoustic structure 100.

In one example, at least one of the first core layer 110 and the second core layer 120 is impregnated with a resin such phenolic resin, vinyl ester, and acrylic with ATH. In another example, both the first core layer 110 and the second core layer 120 are impregnated with a resin. In one example, at least one of the first core layer 110 and the second core layer 120 is chemically treated for fire-resistance. In another example, both the first core layer 110 and the second core layer 120 are chemically treated one or more of borax, ammonium phosphate, and ammonium sulfate for making the material fire resistant, moisture resistant, and mold resistant.

In one example, at least one of the first core layer 110 and the second core layer 120 includes an areal density of less than about 0.5 lb per board foot, or about 0.25 lb per board foot. In another example, at least one of the first core layer 110 and the second core layer 120 includes a thickness ranging from about 0.5″ to about 2″. The first core layer 110 and the second core layer 120 may have substantially the same thickness.

In one example, the acoustic structure 100 further includes a second veneer layer 142 over the second scrim 132 and a first veneer layer 140 over the third scrim 134. The acoustic structure 100 further includes a third veneer layer 144 over a side surface 119, the side surface 119 defined by a stacked structure including the first core layer 110, the second core layer 120, the first scrim 130, second scrim 132, and third scrim 134.

In one example, the first veneer layer 140, the second veneer layer 142, and the third veneer layer 144 are microperforated with a plurality of microperforations 160. Each perforation of the plurality of microperforations 160 has a diameter ranging from about 0.3 mm to about 1 mm. In one example, the plurality of microperforations 160 is present in an amount ranging from about 50,000 microperforations/m² to about 200,000 microperforations/m². In one example, the first veneer layer 140, the second veneer layer 142, and the third veneer layer 144 comprise a cellulosic material. The first veneer layer 140, second veneer layer 142, and third veneer layer 144 may be laminated to the second scrim 132, the third scrim 134, and the side surface 119, respectively, with an adhesive. The adhesive may include polyvinyl acetate. In another example, the first veneer layer 140, the second veneer layer 142, and third veneer layer 144 are screen printed onto the second scrim 132, third scrim 134, and scrim. In one example, the acoustic structure 100 further includes a coating 170 over the first veneer layer 140, the second veneer layer 142, and the third veneer layer 144.

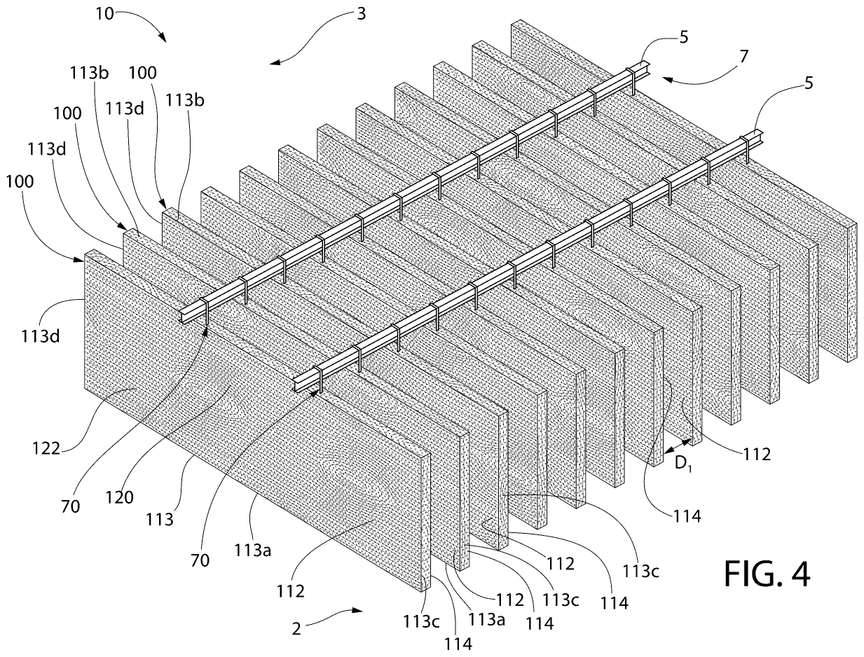

Referring to FIG. 4 and FIG. 5, the disclosed acoustic structure 100 may be part of an acoustic system 10 including more than one acoustic structure 100 or blade (a plurality of blades). In the acoustic system 10, each acoustic structure 100 may be coupled to a support structure 7, such as a strut 5. The support structure 7 may include one or more parallel struts 5. The support structure 7 may be installed into an interior space 2 by attaching strut attachment hardware 6 directly or indirectly to both the struts 5 and a structural barrier 4. In the installed state, the acoustic system 10 may comprise the acoustic structure 100 being supported by the struts 5 of the support structure 7 in the interior space 2 by the panel attachment hardware 70.

In the installed state, each acoustic structure 100 of the plurality of acoustic structure may be horizontally offset by a lateral offset distance D₁ that is a positive non-zero value. Specifically, the later offset distance D₁ may be the distance between the first major exposed surface 112 of a first acoustic structure 100 and the second major exposed surface 114 of an adjacent-most second acoustic structure 100. The lateral offset distance D₁ may range from about 10 cm to about 244 cm—including all distances and sub-ranges there-between.

Also disclosed is a method for manufacturing an acoustic structure 100. The method includes cutting a substrate having a first major surface opposing a second major surface and a lattice structure extending between the first major surface and second major surface to yield a first core layer 110 having a first major surface 116 opposing a second major surface 118. The method further includes cutting the substrate to yield a second core layer 120 having a first major surface opposing a second major surface. The cutting may be performed such that it yields frayed edges of the lattice structures 117, 126. The frayed edges of the lattice structures 117, 126 provide a larger surface area for adhering to the scrims 130, 132, 134.

In one or more examples, the method includes coupling a first scrim 130 to the first major surface 116 of the first core layer 110 and a second scrim 132 to the second major surface 118 of the first core layer 110. The method further includes coupling the first major surface 122 of the second core layer 120 to the first major surface 116 of the first core layer 110 over the first scrim 130. The coupling may be performed such that the lattice structure 117 of the first core layer 110 is offset from the lattice structure 126 of the second core layer 120.

In one or more examples, the method includes coupling a third scrim 134 to the second major surface 124 of the second core layer 120. The coupling may include laminating the third scrim 134 to the second major surface 124 of the second core layer 120. The coupling may further include applying an adhesive to the second major surface 124 prior to positioning the third scrim 134 over the second major surface 124.

The method may further include coupling a first veneer layer 140 to the second major surface 124 of the second core layer 120, coupling a second veneer layer 142 to the second major surface 118 of the first core layer 110 to yield a stacked structure, and coupling a third veneer layer 144 to a side surface 119 of the stacked structure to yield the acoustic structure 100. In one example, the coupling includes applying an adhesive. In another example, the coupling includes laminating. In yet a further example, the coupling includes screen printing.

In one example, at least one of the first core layer 110 and the second core layer 120 includes a cellulosic material. In another example, both the first core layer 110 and the second core layer 120 comprise a cellulosic material. At least one of the first core layer 110 and the second core layer 120 comprises kraft paper. In one example, at least one of the first core layer 110 and the second core layer 120 includes a honeycomb structure. In another example, at least one of the first core layer 110 and the second core layer 120 includes tri-lattice structure. In a further example, the first core layer 110 includes a honeycomb lattice structure and the second core layer 120 includes a tri-lattice structure. The lattice structure 117 of the first core layer 110 may be offset from the lattice structure 126 of the second core layer 120.

In one example, at least one of the first core layer 110 and the second core layer 120 includes is impregnated with a resin such phenolic resin, vinyl ester, and acrylic with ATH. In another example, at least one of the first core layer 110 and the second core layer 120 includes an areal density of less than about 0.5 lb per board foot, or about 0.25 lb per board foot. In a further example, at least one of the first core layer 110 and the second core layer 120 includes a thickness ranging from about 0.5″ to about 2″. The first core layer 110 and the second core layer 120 may have approximately the same thickness.

In one example, the first scrim 130 includes fiberglass. In another example, the first scrim 130, the second scrim 132, and the third scrim 134 comprise fiberglass. In one example, the first scrim 130, the second scrim 132, and the third scrim 134 each have an air flow resistance ranging from about 80 Rayls to about 400 Rayls. The first scrim 130 may have a first airflow resistance, the second scrim 132 may have a second airflow resistance, and the third scrim 134 may have a third airflow resistance. The first and third airflow resistance may be substantially the same and the second airflow resistance may be different than the first and third airflow resistance.

In one example, the method includes applying a coating 170 over the first veneer layer 140, the second veneer layer 142, and the third veneer layer 144. The coating 170 may be a flame-retardant coating. In one example, the first veneer layer 140, the second veneer layer 142, and the third veneer layer 144 are microperforated with a plurality of microperforations 160. In one example, each perforation of the plurality of microperforations 160 has a diameter ranging from about 0.3 mm to about 1 mm. In another example, the plurality of microperforations 160 is present in an amount ranging from about 50,000 microperforations/m² to about 200,000 microperforations/m².

In one example, the first veneer layer 140, the second veneer layer 142, and the third veneer layer 144 comprise a cellulosic material. In another example, the first veneer layer 140, the second veneer layer 142, and the third veneer layer 144 are laminated to the second scrim 132, the third scrim 134, and the side surface 119, respectively, with an adhesive. In one example, the first veneer layer 140, the second veneer layer 142, and the third veneer layer 144 are screen printed onto the second scrim 132, third scrim 134, and side surface 119.

In one example, the cutting yields a first core layer 110 having a side surface defined by frayed edges of the lattice structure. In one example, the method includes a coating over the first veneer layer, the second veneer layer, and the third veneer layer. In one example, the method includes applying an adhesive to the first major surface of the first core layer 110 and the second major surface of the first core layer 110 prior to applying the first scrim and the second scrim. In one example, the method further includes pressing the first scrim against the first major surface and pressing the second scrim against the second major surface of the first core layer 110.

### Exemplary Claims

The disclosure may be further characterized by the following Exemplary Claims

Exemplary Claim 1. An acoustic structure comprising: a core layer having a lattice structure between a first major surface opposing a second major surface and a side surface; a first scrim coupled to the first major surface; a second scrim coupled to the second major surface; a first veneer layer over the first scrim; a second veneer layer over the second scrim; and a third veneer layer over the side surface, wherein the acoustic structure has a bulk density of less than about 12 pounds per cubic foot.

Exemplary Claim 2. The acoustic structure according to Exemplary Claim 1, wherein the core layer comprises a cellulosic material.

Exemplary Claim 3. The acoustic structure according to any one of Exemplary Claims 1 or 2, wherein the core layer comprises kraft paper.

Exemplary Claim 4. The acoustic structure according to any one of Exemplary Claims 1 to 3, wherein the core layer comprises a honeycomb structure.

Exemplary Claim 5. The acoustic structure according to any one of Exemplary Claims 1 to 3, wherein the core layer comprises a tri-lattice structure.

Exemplary Claim 6. The acoustic structure according to any one of Exemplary Claims 1 to 5, wherein the core layer is impregnated with a resin.

Exemplary Claim 7. The acoustic structure according to any one of Exemplary Claims 1 to 6, wherein the core layer comprises a density of less than about 5 pounds per cubic foot.

Exemplary Claim 8. The acoustic structure according to any one of Exemplary Claims 1 to 7, wherein the core layer comprises a thickness ranging from about 0.5″ to about 2″.

Exemplary Claim 9. The acoustic structure according to any one of Exemplary Claims 1 to 8, wherein the first scrim comprises fiberglass.

Exemplary Claim 10. The acoustic structure according to any one of Exemplary Claims 1 to 9, wherein the first scrim and the second scrim comprise fiberglass.

Exemplary Claim 11. The acoustic structure according to any one of Exemplary Claims 1 to 10, wherein the first scrim and the second scrim each have an air flow resistance ranging from about 80 Rayls to about 400 Rayls.

Exemplary Claim 12. The acoustic structure according to any one of Exemplary Claims 1 to 11, further comprising a coating over the first veneer layer, the second veneer layer, and the third veneer layer.

Exemplary Claim 13. The acoustic structure according to any one of Exemplary Claims 1 to 12, wherein the first veneer layer, the second veneer layer, and the third veneer layer are microperforated with a plurality of microperforations.

Exemplary Claim 14. The acoustic structure according to Exemplary Claim 13, wherein each perforation of the plurality of microperforations has a diameter ranging from about 0.3 mm to about 1 mm.

Exemplary Claim 15. The acoustic structure according to any one of Exemplary Claims 13 or 14, wherein plurality of microperforations are present in an amount ranging from about 50,000 microperforations/m² to about 200,000 microperforations/m².

Exemplary Claim 16. The acoustic structure according to any one of Exemplary Claims 1 to 15, wherein the first veneer layer, the second veneer layer, and the third veneer layer comprise a cellulosic material.

Exemplary Claim 17. The acoustic structure according to any one of Exemplary Claims 1 to 16, wherein the first veneer layer is laminated to the first scrim with an adhesive.

Exemplary Claim 18. The acoustic structure according to any one of Exemplary Claims 1 to 17, wherein the first veneer layer is screen printed onto the first scrim.

Exemplary Claim 19. An acoustic structure comprising: a first core layer having a lattice structure between a first major surface and a second major surface; a first scrim coupled to the first major surface of the first core layer; a second scrim coupled to the second major surface of the first core layer; a second core layer having a lattice structure between a first major surface opposite a second major surface coupled to the first scrim; and a third scrim coupled to the second major surface of the second core layer, wherein the acoustic structure comprises a bulk density of less than about 12 pounds per cubic foot.

Exemplary Claim 20. The acoustic structure according to Exemplary Claim 19, wherein at least one of the first core layer and the second core layer comprises a cellulosic material.

Exemplary Claim 21. The acoustic structure according to any one of Exemplary Claims 19 or 20, wherein at least one of the first core layer and the second core layer comprises kraft paper.

Exemplary Claim 22. The acoustic structure according to any one of Exemplary claims 19 to 21, wherein at least one of the first core layer and the second core layer comprises a honeycomb structure.

Exemplary Claim 23. The acoustic structure according to any one of Exemplary claims 19 to 22, wherein at least one of the first core layer and the second core layer comprises a tri-lattice structure.

Exemplary Claim 24. The acoustic structure according to any one of Exemplary claims 19 to 23, wherein the first core layer comprises a honeycomb structure and the second core layer comprises a tri-lattice structure.

Exemplary Claim 25. The acoustic structure according to any one of Exemplary claims 19 to 24, wherein at least one of the first core layer and the second core layer is impregnated with a resin.

Exemplary Claim 26. The acoustic structure according to any one of Exemplary claims 19 to 25, wherein at least one of the first core layer and the second core layer is chemically treated for fire-resistance.

Exemplary Claim 27. The acoustic structure according to any one of Exemplary claims 19 to 26, wherein at least one of the first core layer and the second core layer comprises a density of about less than about 5 pounds per cubit foot.

Exemplary Claim 28. The acoustic structure according to any one of Exemplary claims 19 to 27, wherein at least one of the first core layer and the second core layer comprises a thickness ranging from about 0.5″ to about 2″.

Exemplary Claim 29. The acoustic structure according to any one of Exemplary claims 19 to 28, wherein the first core layer and the second core layer have substantially the same thickness.

Exemplary Claim 30. The acoustic structure according to any one of Exemplary claims 19 to 29, wherein the first core layer and the second core layer are positioned such that the lattice structure of the first core layer is oriented offset from the lattice structure of the second core layer relative to a first axis.

Exemplary Claim 31. The acoustic structure according to any one of Exemplary claims 19 to 30, wherein the first scrim, the second scrim, and the third scrim comprise fiberglass.

Exemplary Claim 32. The acoustic structure according to any one of Exemplary claims 19 to 31, wherein the first scrim, the second scrim, and the third scrim each have an air flow resistance ranging from about 80 Rayls to about 400 Rayls.

Exemplary Claim 33. The acoustic structure according to any one of Exemplary claims 19 to 32, further comprising: a first veneer layer over the second scrim; a second veneer layer over the third scrim; and a third veneer layer over a side surface of a stacked structure defined by the first core layer, the second core layer, the first scrim, the second scrim, and the third scrim.

Exemplary Claim 34. The acoustic structure according to Exemplary Claim 33, wherein the first veneer layer, the second veneer layer, and the third veneer layer are microperforated with a plurality of microperforations.

Exemplary Claim 35. The acoustic structure according to Exemplary Claim 34, wherein each perforation of the plurality of microperforations has a diameter ranging from about 0.3 mm to about 1 mm.

Exemplary Claim 36. The acoustic structure according to any one of Exemplary claims 34 or 35, wherein plurality of microperforations is present in an amount ranging from about 50,000 microperforations/m² to about 200,000 microperforations/m².

Exemplary Claim 37. The acoustic structure according to any one of Exemplary claims 33 to 36, wherein the first veneer layer, the second veneer layer, and the third veneer layer comprise a cellulosic material.

Exemplary Claim 38. The acoustic structure according to any one of Exemplary claims 33 to 37, wherein the first veneer layer is laminated to the second scrim with an adhesive.

Exemplary Claim 39. The acoustic structure according to any one of Exemplary claims 33 to 37, wherein the first veneer layer is screen printed onto the second scrim.

Exemplary Claim 40. The acoustic structure according to any one of Exemplary claims 33 to 39, further comprising a coating over the first veneer layer, the second veneer layer, and the third veneer layer.

Exemplary Claim 41. An acoustic system comprising: a support structure; a first acoustic structure coupled to the support structure; and a second acoustic structure horizontally offset by a lateral offset distance from the first acoustic structure along the support structure; wherein each of the first acoustic structure and the second acoustic structure comprise: a first core layer having a lattice structure between a first major surface opposing a second major surface and a side surface; a first scrim coupled to the first major surface; a second scrim coupled to the second major surface; a first veneer layer over the first scrim; a second veneer layer over the second scrim; and a third veneer layer over a side surface of a stacked structure defined by the first core layer, first scrim, and second scrim, wherein each of the first acoustic structure and the second acoustic structure comprises a density of less than about 5 pounds per cubit foot.

Exemplary Claim 42. The acoustic system according to Exemplary Claim 41, wherein the core layer comprises a cellulosic material.

Exemplary Claim 43. The acoustic system according to any one of Exemplary Claims 41 or 42, wherein the core layer comprises kraft paper.

Exemplary Claim 44. The acoustic system according to any one of Exemplary Claims 41 to 43, wherein the core layer comprises a honeycomb structure.

Exemplary Claim 45. The acoustic system according to any one of Exemplary Claims 41 to 43, wherein the core layer comprises a tri-lattice structure.

Exemplary Claim 46. The acoustic system according to any one of Exemplary Claims 41 to 45, wherein the core layer is impregnated with a resin.

Exemplary Claim 47. The acoustic system according to any one of Exemplary Claims 41 to 46, wherein the core layer comprises a bulk density ranging from about 6 pounds per cubic foot to about 12 pounds per cubic foot.

Exemplary Claim 48. The acoustic system according to any one of Exemplary Claims 41 to 47, wherein the core layer comprises a thickness ranging from about 0.5″ to about 2″.

Exemplary Claim 49. The acoustic system according to any one of Exemplary Claims 41 to 48, wherein the first scrim and the second scrim comprise fiberglass.

Exemplary Claim 50. The acoustic system according to any one of Exemplary Claims 41 to 49, wherein the first scrim and the second scrim each have an air flow resistance ranging from about 80 Rayls to about 400 Rayls.

Exemplary Claim 51. The acoustic system according to any one of Exemplary Claims 41 to 50, wherein the first veneer layer, the second veneer layer, and the third veneer layer are microperforated with a plurality of microperforations.

Exemplary Claim 52. The acoustic system according to any one of Exemplary Claims 41 to 51, wherein each perforation of the plurality of microperforations has a diameter ranging from about 0.3 mm to about 1 mm.

Exemplary Claim 53. The acoustic system according 10 any one of Exemplary Claims 41 to 52, wherein plurality of microperforations are present in an amount ranging from about 50,000 microperforations/m² to about 200,000 microperforations/m².

Exemplary Claim 54. The acoustic system according to any one of Exemplary Claims 41 to 53, wherein the first veneer layer, the second veneer layer, and the third veneer layer comprise a cellulosic material.

Exemplary Claim 55. The acoustic system according to any one of Exemplary Claims 41 to 54, wherein the first veneer layer is laminated to the first scrim with an adhesive.

Exemplary Claim 56. The acoustic system according to any one of Exemplary Claims 41 to 54, wherein the first veneer layer is screen printed onto the first scrim.

Exemplary Claim 57. The acoustic system according to any one of Exemplary Claims 41 to 56, further comprising a coating over the first veneer layer, the second veneer layer, and the third veneer layer.

Exemplary Claim 58. A method for manufacturing an acoustic structure comprising: cutting a substrate having a first major surface opposing a second major surface and a lattice structure extending between the first major surface and second major surface to yield a first core layer having a first major surface opposing a second major surface; cutting the substrate to yield a second core layer having a first major surface opposing a second major surface; coupling a first scrim to the first major surface of the first core layer and a second scrim to the second major surface of the first core layer; coupling the first major surface of the second core layer to the second major surface of the first core layer; coupling a third scrim to the second major surface of the second core layer; coupling a first veneer layer to the first major surface of the first core layer; coupling a second veneer layer to the second major surface of the second core layer to yield a stacked structure; and coupling a third veneer layer to a side surface of the stacked structure to yield the acoustic structure.

Exemplary Claim 59. The method according to Exemplary Claim 58, wherein at least one of the first core layer and the second core layer comprises a cellulosic material.

Exemplary Claim 60. The method according to any one of Exemplary Claims 58 or 59, wherein at least one of the first core layer and the second core layer comprises kraft paper.

Exemplary Claim 61. The method according to any one of Exemplary Claims 58 to 60, wherein at least one of the first core layer and the second core layer comprises a honeycomb structure.

Exemplary Claim 62. The method according to any one of Exemplary Claims 58 to 61, wherein at least one of the first core layer and the second core layer comprises tri-lattice structure.

Exemplary Claim 63. The method according to any one of Exemplary Claims 58 to 62, wherein at least one of the first core layer and the second core layer comprises is impregnated with a resin.

Exemplary Claim 64. The method according to any one of Exemplary Claims 58 to 63, wherein at least one of the first core layer and the second core layer comprises an areal density of less than about 0.5 lb per board foot.

Exemplary Claim 65. The method according to any one of Exemplary Claims 58 to 64, wherein at least one of the first core layer and the second core layer comprises a thickness ranging from about 0.5″ to about 2″.

Exemplary Claim 66. The method according to any one of Exemplary Claims 58 to 65, wherein the first scrim comprises fiberglass.

Exemplary Claim 67. The method according to any one of Exemplary Claims 58 to 66, wherein the first scrim, the second scrim, and the third scrim comprise fiberglass.

Exemplary Claim 68. The method according to any one of Exemplary Claims 58 to 67, wherein the first scrim and the second scrim each have an air flow resistance ranging from about 80 Rayls to about 400 Rayls.

Exemplary Claim 69. The method according to any one of Exemplary Claims 58 to 68, further comprising applying a coating over the first veneer layer, the second veneer layer, and the third veneer layer.

Exemplary Claim 70. The method according to any one of Exemplary Claims 58 to 69, wherein the first veneer layer, the second veneer layer, and the third veneer layer are microperforated with a plurality of microperforations.

Exemplary Claim 71. The method according to Exemplary Claim 70, wherein each perforation of the plurality of microperforations has a diameter ranging from about 0.3 mm to about 1 mm.

Exemplary Claim 72. The method according to any one of Exemplary Claims 70 or 71, wherein plurality of microperforations are present in an amount ranging from about 50,000 microperforations/m 2 to about 200,000 microperforations/m2.

Exemplary Claim 73. The method according to any one of Exemplary Claims 58 to 72, wherein the first veneer layer, the second veneer layer, and the third veneer layer comprise a cellulosic material.

Exemplary Claim 74. The method according to any one of Exemplary Claims 58 to 73, wherein the first veneer layer is laminated to the first scrim with an adhesive.

Exemplary Claim 75. The method according to any one of Exemplary Claims 58 to 73, wherein the first veneer layer is screen printed onto the first scrim.

Exemplary Claim 76. The method according to any one of Exemplary Claims 58 to 75, wherein the cutting yields a first core layer having a side surface defined by frayed edges of the lattice structure.

Exemplary Claim 77. The method according to any one of Exemplary Claims 58 to 76, further comprising applying an adhesive to the first major surface of the first core layer and the second major surface of the first core layer prior to applying the first scrim and the second scrim.

Exemplary Claim 78. The method according to any one of Exemplary Claims 58 to 77, further comprising pressing the first scrim against the first major surface and pressing the second scrim against the second major surface of the first core layer.

### EXAMPLES

The examples and other implementations described herein are exemplary and not intended to be limiting in describing the full scope of compositions and methods of this disclosure. Equivalent changes, modifications and variations of specific implementations, materials, compositions, and methods may be made within the scope of the present disclosure, with substantially similar results.

Various combinations of the above-described disclosure were tested for acoustics and fire resistance. The following materials were used for the tests.
Tricel Core:: Tricel®-1/4-60-60-15%.
CD20 Scrim: glass fiber tissue, 80 gsm.
CX23 Scrim: glass fiber tissue, 135 gsm.
V1 Veneer: microperforated, 2-ply maple veneer.

Table 1 below illustrates the structure of the Examples tested for acoustics. Some Examples included one honeycomb core layer, some included two honeycomb core layers, some included veneers, and some included mixtures of different scrims.

TABLE 1

| | Layer 1 | Layer 2 | Layer 3 | Layer 4 | Layer 5 | Layer 6 | Layer 7 |
|---|---|---|---|---|---|---|---|
| Example 1 | V1 veneer | CX23 scrim | Tricel core | CX 23 scrim | V1 veneer | N/A | N/A |
| Example 2 | V1 veneer | CD20 scrim | Tricel core | CX 23 scrim | Tricel core | CD20 scrim | V1 veneer |
| Example 3 | V1 veneer | CX23 scrim | Tricel core | CX 23 scrim | Tricel core | CX 23 scrim | V1 veneer |

Table 1 exemplifies structure of the Examples tested for air flow resistance and sound absorption.

TABLE 2

| | Example 1 | Example 2 | Example 3 |
|---|---|---|---|
| Thickness (mm) | 13.2 | 24.0 | 23.4 |
| Air flow resistance | 798 | 599 | 1500 |
| (Rayl) | | | |
| Estimated NRC (0 mm | 0.5 | 0.75 | 0.75 |
| air gap) | | | |

Table 2 illustrates Air Flow Resistance and Sound Absorption Coefficients Estimated from Impedance Tube Measurements.

While the present disclosure has been described with reference to several examples, which examples have been set forth in considerable detail for the purposes of making a complete disclosure of the disclosure, such examples are merely representative and are not intended to be limiting or represent an exhaustive enumeration of all aspects of the disclosure. The scope of the disclosure is to be determined from the Claims appended hereto. Further, it will be apparent to those of skill in the art that numerous changes may be made in such details without departing from the spirit and the principles of the disclosure.

What is claimed is:

1. An acoustic structure comprising:
a core layer having a lattice structure between a first major surface opposing a second major surface and a side surface;
a first scrim coupled to the first major surface;
a second scrim coupled to the second major surface;
a first veneer layer over the first scrim;
a second veneer layer over the second scrim; and
a third veneer layer over the side surface,
wherein the acoustic structure has a bulk density of less than about 12 pounds per cubic foot.

2. The acoustic structure according to claim 1, wherein the core layer comprises a cellulosic material.

3. The acoustic structure according to claim 1, wherein the core layer comprises kraft paper.

4. The acoustic structure according to claim 1, wherein the core layer comprises a honeycomb structure.

5. The acoustic structure according to claim 1, wherein the core layer comprises a tri-lattice structure.

6. The acoustic structure according to claim 1, wherein the core layer is impregnated with a resin.

7. The acoustic structure according to claim 1, wherein the core layer comprises a density of less than about 5 pounds per cubic foot.

8. The acoustic structure according to claim 1, wherein the first veneer layer, the second veneer layer, and the third veneer layer are microperforated with a plurality of microperforations.

9. The acoustic structure according to claim 1, wherein the first veneer layer, the second veneer layer, and the third veneer layer comprise a cellulosic material.

10. An acoustic system comprising:
a support structure;
a first acoustic structure coupled to the support structure; and
a second acoustic structure horizontally offset by a lateral offset distance from the first acoustic structure along the support structure;
wherein each of the first acoustic structure and the second acoustic structure comprise:
a first core layer having a lattice structure between a first major surface opposing a second major surface and a side surface;
a first scrim coupled to the first major surface;
a second scrim coupled to the second major surface;
a first veneer layer over the first scrim;
a second veneer layer over the second scrim; and
a third veneer layer over a side surface of a stacked structure defined by the first core layer, first scrim, and second scrim,
wherein each of the first acoustic structure and the second acoustic structure comprises a density of less than about 5 pounds per cubit foot.

11. The acoustic system according to claim 10, wherein the core layer comprises a cellulosic material.

12. The acoustic system according to claim 10, wherein the core layer comprises a honeycomb structure.

13. The acoustic system according to claim 10, wherein the core layer comprises a tri-lattice structure.

14. The acoustic system according to claim 10, wherein the core layer is impregnated with a resin.

15. The acoustic system according to claim 10, wherein the core layer comprises a bulk density ranging from about 6 pounds per cubic foot to about 12 pounds per cubic foot.

16. The acoustic system according to claim 10, wherein the first veneer layer, the second veneer layer, and the third veneer layer are microperforated with a plurality of microperforations.

17. A method for manufacturing an acoustic structure comprising:
cutting a substrate having a first major surface opposing a second major surface and a lattice structure extending between the first major surface and second major surface to yield a first core layer having a first major surface opposing a second major surface;
cutting the substrate to yield a second core layer having a first major surface opposing a second major surface;
coupling a first scrim to the first major surface of the first core layer and a second scrim to the second major surface of the first core layer;
coupling the first major surface of the second core layer to the second major surface of the first core layer;
coupling a third scrim to the second major surface of the second core layer;
coupling a first veneer layer to the first major surface of the first core layer;
coupling a second veneer layer to the second major surface of the second core layer to yield a stacked structure; and
coupling a third veneer layer to a side surface of the stacked structure to yield the acoustic structure.

18. The method according to claim 17, wherein the first veneer layer, the second veneer layer, and the third veneer layer are microperforated with a plurality of microperforations.

19. The method according to claim 17, further comprising applying an adhesive to the first major surface of the first core layer and the second major surface of the first core layer prior to applying the first scrim and the second scrim.

20. The method according to claim 17, further comprising pressing the first scrim against the first major surface and pressing the second scrim against the second major surface of the first core layer.
